(19) United States
(12) Patent Application Publication
(10) Pub. No.: US 2007/0161348 A1
(43) Pub. Date: Jul. 12, 2007

(54) Cellular base station subsystem

(76) Inventors: Douglas Alan Gribben, Murphy, TX (US); Harold Edmond Asbridge JR., Rowlett, TX (US)

Correspondence Address: Eric D. Cohen;22nd Floor, 120 South Riverside Plaza, Chicago, IL, 60606-3945, US

(21) Appl. No.: 11/327,764

(22) Filed: Jan. 6, 2006

(51) Int. Cl. H04B 7/185; H04B 1/38

(52) U.S. Cl. 455/13.3; 455/561

(57) ABSTRACT

A method of operating a cellular base station subsystem such as a smart bias tee. The method comprising: modulating a first control data signal to generate a first modulated carrier signal; multiplexing said first modulated carrier signal with a first RF antenna signal onto a feed line; demultiplexing a second RF antenna signal and a second modulated carrier signal from said feed line; demodulating the second modulated carrier signal to generate a second control data signal; analyzing at least one of said signals to generate diagnostic data; and outputting said diagnostic data. The subsystem also has an addressable memory adapted to provide data on request from said subsystem.

### FIELD OF THE INVENTION

The present invention is related to a subsystem of a cellular base station.

### BACKGROUND OF THE INVENTION

Cellular communication systems employ a plurality of antenna systems, each serving a sector or area commonly referred to as a cell. The collective cells make up the total service area for a particular wireless communication network.

Serving each cell is an antenna array and associated switches connecting the cell into the overall communication network. Typically, the antenna array is divided into sectors, where each antenna serves a respective sector. For instance, three antennas of an antenna system may serve three sectors, each having a range of coverage of about 120°. These antennas typically have some degree of downtilt such that the beam of the antenna is directed slightly downwardly towards the mobile handsets used by the customers. This desired downtilt is often a function of terrain and other geographical features. However, the optimum value of downtilt is not always predictable prior to actual installation and testing. Thus, there may be a need for custom setting of each antenna downtilt upon installation of the actual antenna. Downtilt is commonly set by a Remote Electrical Downtilt device (RET).

The Antenna Interface Standards Group (AISG) has created an open specification for the control interface for devices such as RETs and Tower Mounted Amplifiers (TMAs). The AISG specification permits the use of a subsystem commonly known as a “smart bias tee”, “modem bias tee”, or “layer one converter (LOC)”, to combine RF and digital control signals.

An intelligent multiplexer is described in US 2002/0132644. A data signal is extracted from an input signal, the data signal including values representing operating parameters of a device at a radiation element (such as a Mast Head Amplifier).

### SUMMARY OF EXEMPLARY EMBODIMENTS

The exemplary embodiment of the invention provides a method of operating a cellular base station subsystem, the method comprising: modulating a first control data signal to generate a first modulated carrier signal; multiplexing said first modulated carrier signal with a first RF antenna signal onto a feed line; demultiplexing a second RF antenna signal and a second modulated carrier signal from said feed line; demodulating the second modulated carrier signal to generate a second control data signal; analyzing at least one of said signals to generate diagnostic data; and outputting said diagnostic data.

The exemplary embodiment of the invention further provides a cellular base station subsystem comprising: a modulator adapted to modulate a first control data signal to generate a first modulated carrier signal; a multiplexer adapted to multiplex said first modulated carrier signal with a first RF antenna signal onto a feed line; a demultiplexer adapted to demultiplex a second RF antenna signal and a second modulated carrier signal from said feed line; a demodulator adapted to demodulate the second modulated carrier signal to generate a second control data signal; and a monitor adapted to analyze at least one of said signals to generate diagnostic data and output said diagnostic data.

The exemplary embodiment of the invention further provides a method of operating a cellular base station subsystem, the method comprising: modulating a first control data signal to generate a first modulated carrier signal; multiplexing said first modulated carrier signal with a first RF antenna signal onto a feed line; demultiplexing a second RF antenna signal and a second modulated carrier signal from said feed line; demodulating the second modulated carrier signal to generate a second control data signal; requesting data from said subsystem; and providing data from a memory of said subsystem in response to the request.

The exemplary embodiment of the invention further provides a cellular base station subsystem comprising: a modulator adapted to modulate a first control data signal to generate a first modulated carrier signal; a multiplexer adapted to multiplex said first modulated carrier signal with a first RF antenna signal onto a feed line; a demultiplexer adapted to demultiplex a second RF signal and a second modulated carrier input signal from said feed line; a demodulator adapted to demodulate the second modulated carrier signal to generate a second control data signal; and an addressable memory adapted to provide data on request from said subsystem.

### BRIEF DESCRIPTION OF THE DRAWINGS

The accompanying drawings which are incorporated in and constitute part of the specification, illustrate embodiments of the invention and, together with the general description of the invention given above, and the detailed description of the embodiments given below, serve to explain the principles of the invention.

FIG. 1 shows a wireless cellular communication system;

FIG. 2 shows a BTS;

FIG. 3 shows the BTS in more detail; and

FIG. 4 shows the smart bias tees in more detail.

### DETAILED DESCRIPTION OF EMBODIMENT(S)

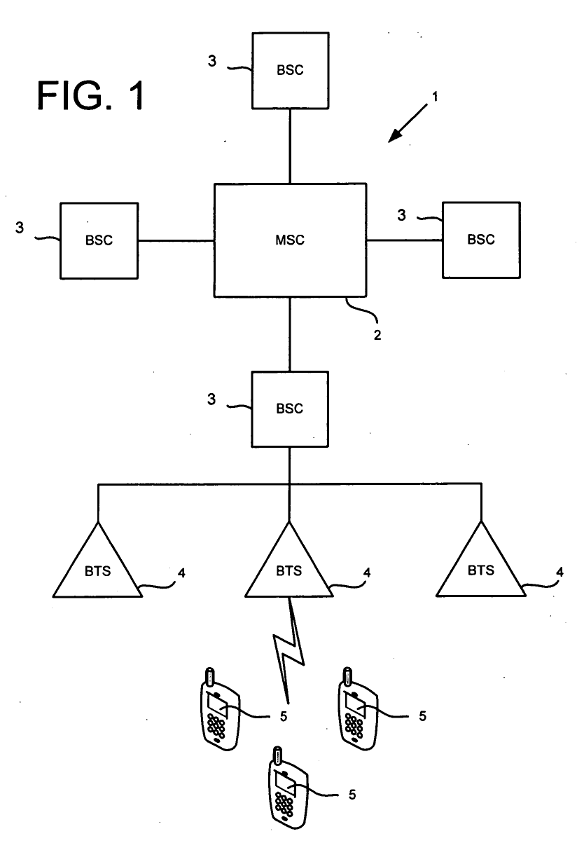

FIG. 1 shows a wireless cellular communication system 1. A Mobile Switching Centre (MSC) 2 interfaces with a network of Base Station Controllers (BSCs) 3. Each BSC interfaces with a number of Base Transceiver Stations (BTSs) 4, also known as base stations. Each BTS 4 interfaces with a number of Mobile Station (MSs) 5.

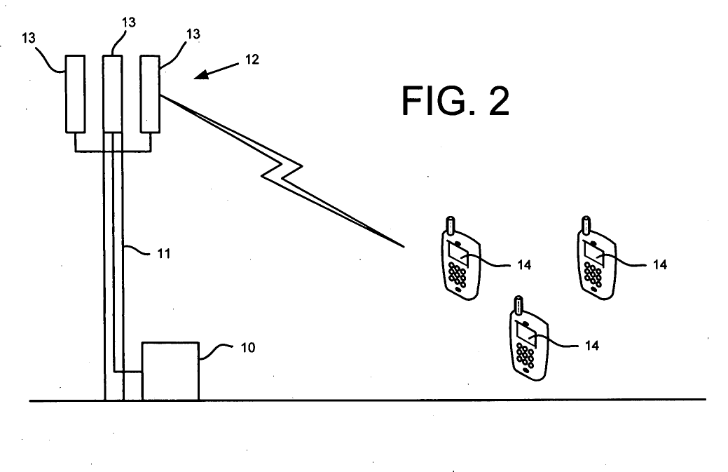

An exemplary one of the BTSs 4 is shown in FIG. 2. The base station comprises a system 10 at the base of a BTS tower 11, and a system 12 at the top of the tower 11. System 12 comprises three antennae 13, each of which interfaces with Mobile Stations (MSs) 14 in a respective cell via a respective beam.

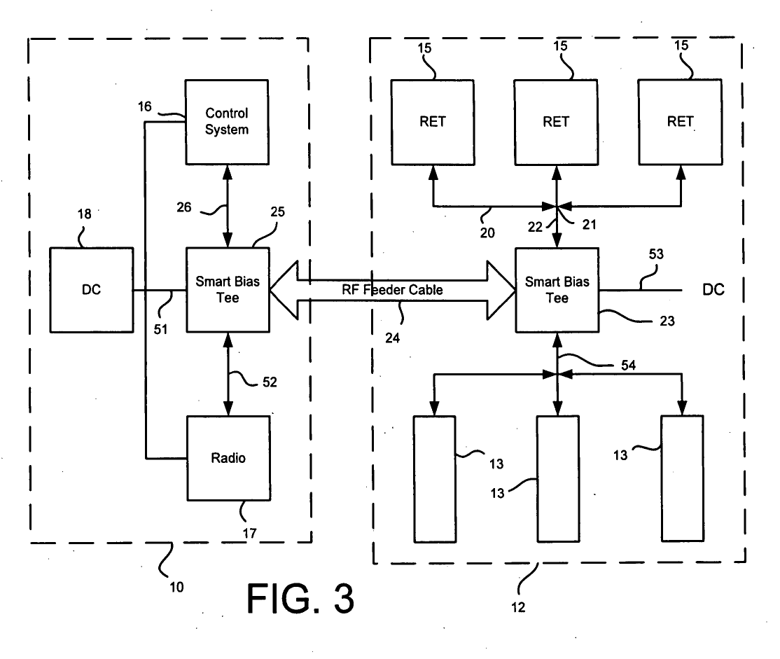

Referring to FIG. 3, an electrical downtilt of each antenna beam is controlled by a respective Remote Electrical Tilt (RET) device 15. System 10 comprises a control subsystem 16 which interfaces with the RETs 15, a radio 17 which interfaces with the antennae 13, and a DC power supply 18 which provides DC power for all components of the systems 10 and 12.

The control subsystem 16 generates RET control data which is transmitted over a point-to-multipoint serial network to the RETs 15, each of which is assigned a unique bus address, and the RETs generate RET status data which is returned to the control subsystem 16. Similarly, the radio 17 transmits downlink RF signals to the antennae 13, and receives uplink RF signals from the antennae 13.

The RET control data on line 26, a DC bias signal on line 51, and the downlink RF signals on line 52, are multiplexed onto a single coaxial RF feeder cable 24 by a first smart bias tee 25 in the system 10. A second smart bias tee 23 in the system 12 demultiplexes the RET control data onto a line 22, the DC bias signal onto a line 53, and the downlink RF signals onto a line 54. Similarly, the RET status data and the uplink RF signals are multiplexed onto the cable 24 by the second smart bias tee 23, and the first smart bias tee 25 demultiplexes the RET status data and uplink RF signals from the cable 24.

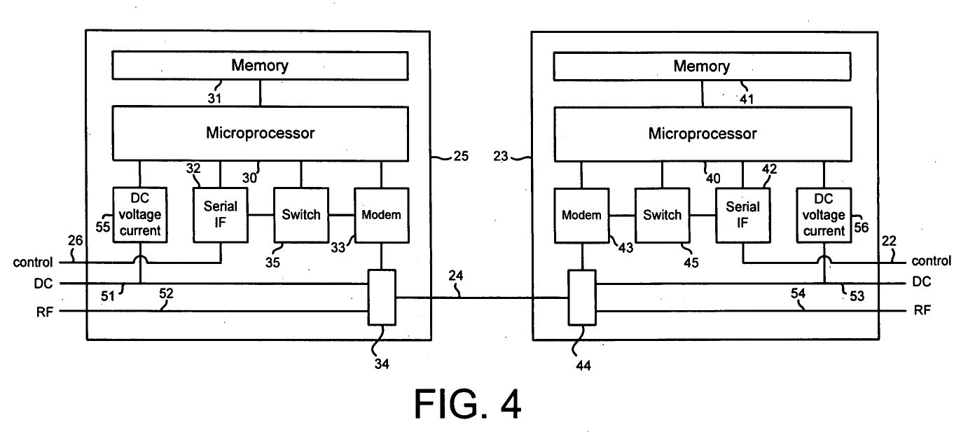

The smart bias tees 23,25 incorporate microprocessors 30, 40 shown schematically in FIG.4. These microprocessors can be addressed for routine monitoring purposes, without requiring an operator to climb the tower 11 to attach specialist equipment, and without disturbing the RF path to the antennae 13.

The smart bias tees consist of these microprocessors 30, 40, configuration memories 31, 41, serial interfaces 32, 42, connecting switches 35, 45, modems 33, 43, multiplexer/demultiplexer elements 34, 44, and DC voltage and/or current measurement devices 55,56.

Referring first to smart bias tee 25, the serial interface 32 processes control data in the form of a series of frames. If the switch 35 is ON, then the switch passes control data to and from the modem 33. The modem 33 modulates/demodulates the control data onto/from a carrier signal which is transmitted together with the DC bias signal and RF signal by the coaxial cable 24. If the switch 35 is OFF then it prevents the passage of data between the serial interface 32 and modem 35. The smart bias tee 23 is essentially a mirror image of the smart bias tee 25 and operates in a similar fashion.

An AISG1 2.0 or similar industry-standard protocol stack is installed on each microprocessor 30,40 and, using this stack, the microprocessor 30,40 may actively respond as a secondary station on the serial point-to-multipoint network through the same address assignment mechanisms used by the RETs 15, establishing a data link. This link enables the microprocessors to provide various data to the control subsystem 16 which enable the control subsystem 16 to carry out various functions using software protocols compatible with those already being used to control the RETs.

In general terms, the microprocessors provide two functions. Firstly they act as monitors to analyze the performance of the smart bias tee and generate associated diagnostic data which can be output to the control subsystem 16 and/or to the memory 31,41. Secondly, in combination with their associated memory 31,41, they provide an addressable source of data associated with the smart bias tee.

More specifically, data accepted by the microprocessors includes:
Switching Commands to enable and disable the switches 35,45 to electrically isolate sections of the system
Commands to assign point-to-multipoint bus addresses to the smart bias tee devices

Data output by the microprocessors includes:
status check data reporting the presence of bias tee
protocol error data
modem measurements and statistics
provisioning information
DC information

These various types of data will now be described in further detail below.

Continuity Check

In the event of a fault, it is desirable for the control subsystem 16 to make a continuity check of all of the transmission lines and nodes in the point-to-multipoint serial network between the control subsystem 16 and the RETs 15 to isolate faulty connections or failed components. In other words, if RET status data is not being received from the RET connected to line 20, then this could be due to a fault in line 20, star connection 21, line 22, smart bias tee 23, RF feeder cable 24, smart bias tee 25 or line 26.

In the event of a loss of RET status data from the RET 15 connected to line 20, then the control subsystem 16 can request status check data from the microprocessor 40 in the second bias tee 23. In response to the request, the microprocessor 40 acquires the status check data from the memory 31 and provides it to the control subsystem 16.

If the control subsystem 16 receives status check data from the microprocessor 40 then by a process of elimination the problem must be in the RET network (that is, in the RET 15, one of the lines 20,22 or the star connection 21), the switch 45 or the serial interface 42. If it receives no response, it can attempt to send an isolation command message to the microprocessor 40 commanding it to turn OFF switch 45, isolating the RET network from the bias tee 23. If it then receives a response, the problem must lie in the RET network. Because the fault may inhibit normal communications over the entire bus, these isolation command messages must not require acknowledgement or the establishment of an error-free link in advance. Therefore memory 41 is required so that the smart bias tee 23 can retain a permanent bus address for this purpose. If it receives no response, then by a process of elimination the problem must be in one of the lines 24,26, the smart bias tee 25, the multiplexer/demultiplexer 44, the modem 43 or the microprocessor 40. The control subsystem 16 can then interrogate the microprocessor 30 in the first bias tee 25. If it receives no response, it can attempt to send an isolation command message to microprocessor 30 commanding it to disconnect switch 35, here using a stored address in memory 31, isolating the RET network from the bias tee 25. If it then receives a response, the problem must lie between the modem 33 and the microprocessor 40. If it receives no response, then by a process of elimination the problem must be in the line 26, the serial interface 32 or the microprocessor 30. In this way the location of the fault may be often narrowed and unnecessary maintenance operations eliminated.

Status Check

As noted above, status check data can be requested from the microprocessors as part of a continuity check procedure. In addition, status check data can be requested from the microprocessors in a regular polling procedure in which network control equipment (such as control subsystem 16, BSC 3 or MSC 2) requests status checks from all devices having an address, including the microprocessors 40,41, RETs 15, and any other addressable devices such as TMAs etc.

Protocol Check

The microprocessors 30,40 each receive a series of frames of control data from their associated serial interface and modem. As the microprocessor receives this data, it analyzes the control data to generate protocol error data. The protocol error data consists principally of:
total frame count
character framing error counters
incorrect frame check sequence value counters
oversized frame counters
undersized frame counters

The presence of elevated counters above 1/5000^{th} of the total frame count indicates degraded communications, as set out in the AISG specification.

Modem Measurements and Statistics

The microprocessors measure the performance of their respective modem and acquire various modem data. One example of this data is for the microprocessors to measure the signal strength of the carrier signal received by their respective modem. The microprocessor can then notify the control subsystem 16 if the carrier signal falls outside specified limits. If the carrier signal is too strong then the carrier signal may leak through filters (not shown), and if the carrier signal is too weak then it may cause protocol errors or intermittent failure.

Provisioning Information

The microprocessors may receive and store various provisioning information such as installer ID, date of installation and other operational records. The provisioning information may then be output on request to network control equipment such as control subsystem 16, BSC 3 or MSC 2.

DC Information

Devices 55,56 measure the voltage and/or current of the DC bias signal, and these measurements are received and stored by their associated microprocessor. The DC measurements may then be output on request to network control equipment such as control subsystem 16, BSC 3 or MSC 2.

The point-to-multipoint network described above is used to control an array of RETs, but it will be understood that other devices may be controlled instead of (or in addition to) RETs, such as Tower Mounted Amplifiers (TMAs).

The smart bias tees may be stand alone subsystems as in the embodiment described above, or may be integrated into another subsystem such as a Tower Mounted Amplifier (TMA).

Although the system described above employs a modem (that is, an integrated modulation/demodulation unit) it will be understood that the modulation and demodulation functions may be performed by separate units. Similarly, although the system described above employs an integrated multiplex/demultiplex unit, it will be understood that the multiplexing and demultiplexing functions may be performed by separate units

Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

What is claimed is:

1. A method of operating a cellular base station subsystem, the method comprising: modulating a first control data signal to generate a first modulated carrier signal; multiplexing said first modulated carrier signal with a first RF antenna signal onto a feed line; demultiplexing a second RF antenna signal and a second modulated carrier signal from said feed line; demodulating the second modulated carrier signal to generate a second control data signal; analyzing at least one of said signals to generate diagnostic data; and outputting said diagnostic data.

2. A method according to claim 1 comprising analyzing the first or second control data signal to generate said diagnostic data.

3. A method according to claim 1 comprising analyzing the first or second modulated carrier signal to generate said diagnostic data.

4. A method according to claim 3 comprising measuring the signal strength of the first or second modulated carrier signal to generate said diagnostic data.

5. A method according to claim 1 further comprising storing said diagnostic data in an addressable memory of said subsystem.

6. A method according to claim 1 further comprising multiplexing a DC bias signal onto said feed line.

7. A method according to claim 1 further comprising demultiplexing a DC bias signal from said feed line.

8. A cellular base station subsystem comprising: a modulator adapted to modulate a first control data signal to generate a first modulated carrier signal; a multiplexer adapted to multiplex said first modulated carrier signal with a first RF antenna signal onto a feed line; a demultiplexer adapted to demultiplex a second RF antenna signal and a second modulated carrier signal from said feed line; a demodulator adapted to demodulate the second modulated carrier signal to generate a second control data signal; and a monitor adapted to analyze at least one of said signals to generate diagnostic data and output said diagnostic data.

9. A method of operating a cellular base station subsystem, the method comprising: modulating a first control data signal to generate a first modulated carrier signal; multiplexing said first modulated carrier signal with a first RF antenna signal onto a feed line; demultiplexing a second RF antenna signal and a second modulated carrier signal from said feed line; demodulating the second modulated carrier signal to generate a second control data signal; requesting data from said subsystem; and providing data from a memory of said subsystem in response to the request.

10. A method according to claim 9 further comprising assigning a network address to the subsystem, storing the network address in the memory; and requesting data from the memory using the network address.

11. A method according to claim 9 wherein the subsystem is part of a point-to-multipoint network between a controller and a plurality of controlled devices; and the data is requested from the memory in order to perform a continuity check of the network.

12. A method according to claim 11 wherein the point-to-multipoint network comprises two of said subsystems, and wherein the method comprises requesting data from a memory of each of said subsystems in order to perform a continuity check of the network.

13. A method according to claim 11 further comprising isolating the subsystem from said plurality of controlled devices; and requesting data from said memory when said subsystem is isolated from said plurality of controlled devices.

14. A method according to claim 9 further comprising multiplexing a DC bias signal onto said feed line.

15. A method according to claim 9 further comprising demultiplexing a DC bias signal from said feed line.

16. A cellular base station subsystem comprising: a modulator adapted to modulate a first control data signal to generate a first modulated carrier signal; a multiplexer adapted to multiplex said first modulated carrier signal with a first RF antenna signal onto a feed line; a demultiplexer adapted to demultiplex a second RF signal and a second modulated carrier input signal from said feed line; a demodulator adapted to demodulate the second modulated carrier signal to generate a second control data signal; and an addressable memory adapted to provide data on request from said subsystem.
